(19) United States
(12) Patent Application Publication
(10) Pub. No.: US 2006/0126175 A1
(43) Pub. Date: Jun. 15, 2006

(54) Viewing screens including carbon materials and methods of using

(76) Inventors: Zhijian Lu, Belle Mead, NJ (US); Ilyas I. Khayrullin, Flanders, NJ (US)

Correspondence Address: Ronald D. Trice, 7020 Rhoden Ct., 103, Springfield, VA, 22151, US

(21) Appl. No.: 11/212,905

(22) Filed: Aug. 29, 2005

Related U.S. Application Data
(60) Provisional application No. 60/606,466, filed on Sep. 2, 2004.

(51) Int. Cl. G03B 21/56

(52) U.S. Cl. 359/460; 359/443

(57) ABSTRACT

Viewing screens having highly light absorptive carbon nanotubes, fullerenes and/or fullerides dispersed in a resinous or polymeric material as part of the light absorbing material located between the light transmission apertures. The highly light absorptive composite of carbon nanotubes, fullerenes and/or fullerides and polymeric material may be conductive. A voltage potential having DC and/or AC components or a ground potential may be applied to the surface of the viewing screen. Such a potential may be selected such that it prevents or reduces the build-up of dust on the viewing screen.

### RELATED APPLICATIONS

This application claims priority from, and incorporates by reference, U.S. Provisional application Ser. No. 60/606,466, filed Sep. 2, 2004.

### FIELD OF THE INVENTION

The present invention relates generally to viewing screens including carbon materials and methods of using, and more particularly, to viewing screens including carbon nanotubes, fullerenes and fullerides and methods of using.

### BACKGROUND

Certain types of viewing screens for rear projection and direct view displays pass light through small apertures of optically clear material, such as acrylate. The area between these apertures may include light absorbing material that is useful in absorbing ambient light such as room light or sun light. However, even with conventional light absorbing material, the quality of the observed image is impaired by the ambient light due to reflection and scattering from the screen. This impairment often becomes more noticeable as a screen become dustier or scratched. Accordingly, there is a strong need in the art for a viewing screen that is able to absorb more ambient light, reduces dust build up and has higher mechanical strength.

### SUMMARY OF THE INVENTION

An aspect of the present invention is to provide a viewing screen including a plurality of light transmission areas and a plurality of light absorption areas. The light absorption areas including a composite of resinous or polymeric material and at least one of carbon nanotubes, fullerenes or fullerides.

Another aspect of the invention is to provide a viewing screen including a rear -projection screen surface having a plurality of light transmission areas and a plurality of light absorption areas, the light absorption areas including conductive at least one of carbon nanotubes, fullerenes or fullerides embedded in a resinous or polymeric material. A voltage potential is selected to reduce the accumulation of dust particles on the viewing screen surface.

Another aspect of the invention is to provide a method of preventing particle accumulation on a viewing screen including providing a viewing screen surface having a plurality of light transmission areas and a plurality of light absorption areas, the light absorption areas including conductive at least one of carbon nanotubes, fullerenes or fullerides embedded in a resinous or polymeric material and applying a voltage potential selected to reduce the accumulation of dust particles on the viewing screen surface.

### BRIEF DESCRIPTION OF THE DRAWINGS

The invention will be described in detail with reference to the following drawings in which like reference numerals refer to like elements wherein:

FIG. 1 illustrates a top view of an exemplary viewing screen having a plurality of light transmitting apertures with a light absorbing composite material between the plurality of light transmitting apertures;

FIG. 2 illustrates a cross sectional view of the viewing screen of FIG. 1;

FIG. 3 illustrates an exemplary rear projection display incorporating the viewing screen of FIG. 1; and

FIG. 4 illustrates an exemplary direct view liquid crystal display incorporating the viewing screen of FIG. 1.

### DETAILED DESCRIPTION

Viewing screens with light transmitting apertures and light absorbing material between the apertures may be improved by incorporating highly light absorptive carbon nanotubes, fullerenes and/or fullerides in the light absorbing material. Moreover, by using carbon nanotubes, fullerenes and/or fullerides that have a conductance that falls in the conductive range rather than insulative or semiconductor ranges, a voltage potential may be applied to the surface of the viewing screen. This voltage potential may have DC and/or AC components or may be a ground potential. Such a potential may be selected such that it prevents or reduces the build-up of dust on the viewing screen. For example, a small voltage potential that has a positive DC potential would repel particles having a positive polarity charge polarity.

Carbon nanotubes are a type of nanostructure which may be thought of as a sheet of graphene rolled into a cylindrical tube with bonds at the end of the sheet forming the bonds with another end of the sheet that close the tube. A carbon nanotube, described according to conformation as (n, m), is metallic when n equal m (corresponding to armchair tube), and semiconducting for other combinations of n and m (zigzag and chiral tubes). Such carbon nanotubes include single wall and multi-wall nanotubes and may be straight, bent, rolled, waved and many other conformations. Carbon nanotubes may be made by laser evaporation, carbon arc discharge method, chemical vapor deposition or any other suitable method. Carbon nanotubes are commercially available from Hyperion Catalysis International, Inc. of Cambridge, Mass., and Carbolex, Inc. of Lexington, Ky. Further description of carbon nanotubes may be found in “Physical Properties of Carbon Nanotubes,” Imperial College Press, London U.K. 1998, and “Introduction to Nanotechnology,” John Wiley & Sons, Inc. 2003. The carbon nanotubes may be either aligned or unaligned in the polymeric material. The alignment of the carbon nanotubes may be provided by extrusion shearing force, injection shearing force, stretching shearing force or any other suitable alignment method.

Fullerenes and fullerides are another class of carbon based materials. Fullerene has general formula Cₙ, where n can be as small as twenty and as large as several hundred, and having spherical or close to spherical shell structure. For example, the fullerene Buckminsterfullerene C₆₀ has the carbon atoms arranged in a geometric shape consisting of 12 pentagons and 20 hexagons. Fullerenes may be formed by vaporized carbon condensing in an atmosphere of inert gas. Various techniques may be used to produce carbon vapor including a pulsed laser evaporation, arc discharge, or any other suitable technique. The released carbon atoms form clusters in a stream of inert gas and further assemble into fullerene shells. Fullerides are fullerenes doped with metals. Upon doping, the conductivity of fullerene may be dramatically increased. The dopant includes, but not limited to, metals such alkali metals (e.g., potassium, rubidium, etc.). Fullerenes further include multi-walled shells or so called carbon onions. Similarly to Russian dolls, this type of fullerene may include concentric spherical layers stacked one inside the other. The size of carbon onions varies from few nanometers to tens of nanometers. These objects are larger than the typical fullerenes, but very often smaller than the carbon nanotubes. Carbon onions may be produced by electron irradiation of polyhedral carbon particles which are present in the soot of arc discharge experiments, by heat treatment of diamond nanoparticles, and by high-dose carbon ion implantation into copper foil. Fullerenes are commercially available from Texas Fullerene Corporation of Houston, Tex., Arizona Fullerene Consortium of Tucson, Ariz., BuckyUSA of Bellaire, Tex., and Hyperion Catalysis International of Cambridge, Mass. Further description of fullerenes and fullerides may be found in “The Fullerenes: New Horizons for the Chemistry, Physics and Astrophysics of Carbon” edited by H. W. Kroto and D. R. M. Walton, Cambridge University Press, 1993, and in “Fullerenes: Chemistry, Physics, and Technology” edited by K. Kadish, et al. Wiley-Interscience, 2000.

The carbon nanotubes, fullerenes and/or fullerides may be combined with a wide range of resinous and/or polymeric materials including both natural and synthetic polymeric materials. Such resinous or polymeric materials may be thermoplastic, thermoset, or ultra-violet (UV) curable. For example, suitable polymeric materials include, but not limited to, polystyrene, polycarbonate, polyetherimide, ethylene vinyl acetate, polypropylene, polyethylene terephthalate, polybutylene terephthalate, nylon, polyetherketone, polyphenylene sulfide, polyimide, polyvinyl chloride, acrylics, phenolics, polyesters, polyparaphenylene, polyaniline, and the like. Additionally, the polymeric material may be conductive polymeric material (e.g., polyparaphenylene and polyaniline) to increase the conductivity of the light absorbing material, increase the absorbance of light and bind the carbon nanotubes, fullerenes and/or fullerides to the viewing screen or other device. The resinous or polymeric material may be a mixture of two or more resins or polymers. The carbon nanotubes, fullerenes or fullerides may be homogenously distributed in the resinous or polymeric material. The amount of the carbon nanotubes, fullerenes or fullerides in the composite is selected such that the carbon nanotubes, fullerenes or fullerides are from 0.01% to 25% by weight of the composite. Alternatively, the weight percent may be from 0.1% to 10% by weight of the composite, or even from 1% to 5% by weight of the composite. The thickness of the composite may be made to be less than 2 mm thick.

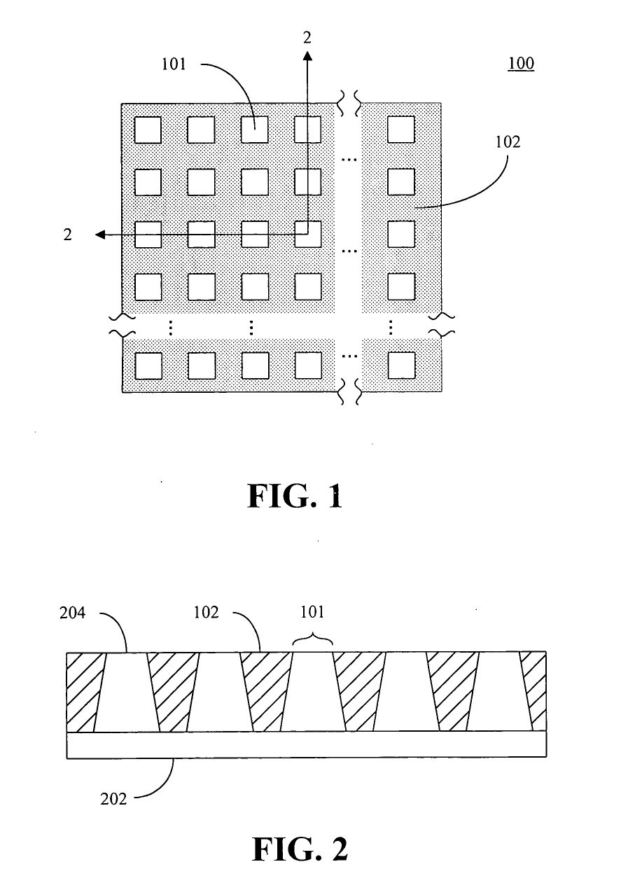

FIG. 1 illustrates a top view of an exemplary viewing screen 100 having a plurality of light transmitting apertures 101 with light absorbing material 102 between the plurality of light transmitting apertures 101. As is illustrated, the area of the plurality of light transmitting apertures 101 is much smaller than the area corresponding to the light absorbing material 102 on the front surface (towards viewers) of the viewing screen 100. Thus, the efficacy with which the light absorbing material attenuates ambient light substantially determines the amount of degradation of the projected image resultant from ambient light (sometimes called wash-out). Thus, the viewing screen 100 of FIG. 1 will have a reduced wash-out since the carbon nanotubes, fullerenes and/or fullerides have excellent light absorption properties. In other words, the carbon nanotubes, fullerenes and/or fullerides which are part of light absorbing material 102 appear to be very black and result in a viewing screen 100 that has reduced wash-out.

Unfortunately, the attenuation of ambient light by the viewing screen 100 may be impaired by the accumulation of dust on the surface of the viewing screen 100. This dust impairs the absorption of ambient light because the dust is not black and does not sufficiently absorb ambient light. However, it is possible to reduce the accumulation of dust by including conductive carbon nanotubes, fullerenes and/or fullerides and biasing the surface of the viewing screen 100.

The surface of the viewing screen 100 may be neutrally biased (i.e., grounded) so as to prevent attraction of either positively or negatively charged particles. The surface of the viewing screen 100 may also be positively charged, to repel positively charged dust particles, or be negatively charged, to repel negatively charged dust particles. Alternatively, the accumulated (positively or negatively) charged or neutral dust particles may be forced away from the surface of the viewing screen 100 by periodically reversing the bias applied to the viewing screen 100. This reversal of bias would be sufficiently long to allow the dust particles forced from the surface to fall or float away, thereby “cleaning” the viewing screen 100 of dust. The reversal of bias may be applied in phase with an electronic circuitry in the projection system for the viewing screen 100, in periodic AC waveform or in any other suitable waveform.

FIG. 2 illustrates a cross sectional view of the viewing screen 100 of FIG. 1. The light absorbing material 102 is deposited or otherwise formed between the plurality of light transmitting apertures 101. The light absorbing material 102 also may be deposited or otherwise formed such that a thin film of light absorbing material 102 covers the top of the light transmitting apertures 101. The thickness of the light absorbing material 102 is selected so as not to significantly reduce the transmission of light from the light transmitting apertures 101. Alternatively, only the polymeric material part of the light absorbing material 102 may be deposited on the top of the light transmitting apertures 101. The viewing screen 100 may also include a support structure such as an optically clear substrate 202.

The plurality of light transmitting apertures 101 may be formed from any suitable optically transmitting material 204 and have any suitable shape. For example, the shape of the plurality of light transmitting apertures 101 may be tapered rectangular cones, tapered cubic cones, tapered circular cones, tapered elliptical cones, tapered rectangular stripes, tapered circular stripes, untapered rectangular cones, untapered cubic cones, untapered circular cones, untapered elliptical cones, untapered rectangular stripes, untapered circular stripes or any other suitable geometry and the plurality of light transmitting apertures 101 may be formed from diacrylate, triacrylate, mixtures of ethoxylated bisphenol A diacrylate and trimethylol propane triacrylate, or other optically clear materials. The plurality of light transmitting apertures 101 may be formed through photopolymerization process, micro-replication (e.g. stamping) or any other suitable methods.

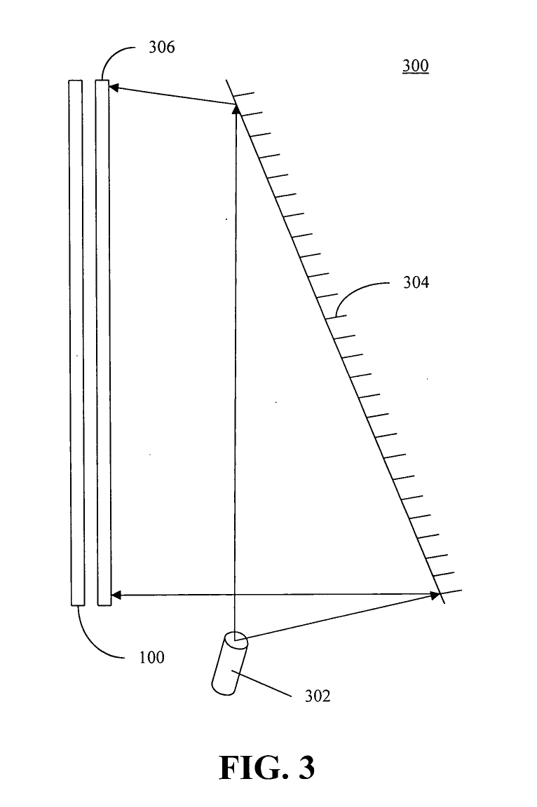

FIG. 3 illustrates an exemplary rear projection display 300 incorporating the viewing screen 100 of FIG. 1, a light projection system 302, a mirror 304, a Fresnel lens 306. The light projection system 302 projects an image which is reflected by the mirror 304, through the Fresnel lens 306 and then onto the viewing screen 100.

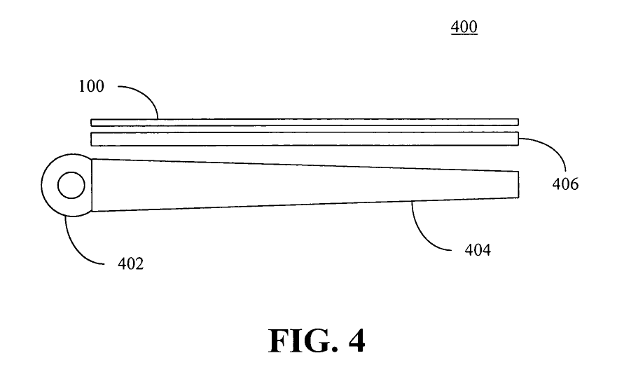

FIG. 4 illustrates an exemplary direct view liquid crystal display 400 incorporating the viewing screen 100 of FIG. 1, a light source 402 such as fluorescent light tube, a light guide and diffuser 404, and an image generating element 406 such as a twisted nematic liquid crystal display. The light generated from the light source 402 may be partially guided and diffused in the light guide and diffuser 404. The light exiting the light guide and diffuser 404 enters the image generating element 406. The light containing the image information then is spread to large range of angles by the viewing screen 100. In addition to providing high quality image and enhanced mechanical strength, the viewing screen 100 may be manufactured less expensively and with fewer processing steps since the black matrix commonly included in the image generating element 406 may be omitted.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

1. A viewing screen comprising:
a plurality of light transmission areas and a plurality of light absorption areas, the light absorption areas including a composite of resinous or polymeric material and at least one of carbon nanotubes, fullerenes or fullerides.

2. (canceled)

3. The screen of claim 1, wherein the at least one of carbon nanotubes, fullerenes or fullerides are homogenously distributed in the resinous or polymeric material.

4. The screen of claim 1, wherein the composite has a thickness less than 2 mm.

5. The screen of claim 1, wherein the at least one of carbon nanotubes, fullerenes or fullerides are from 0.01 to 25 weight percent of the composite.

6. The screen of claim 1, wherein the at least one of carbon nanotubes, fullerenes or fullerides are from 0.1 to 10 weight percent of the composite.

7. The screen of claim 1, wherein the at least one of carbon nanotubes, fullerenes or fullerides are from 1 to 5 weight percent of the composite.

8. The screen of claim 1, wherein the composite includes fullerenes or fullerides.

9. The screen of claim 1, wherein the composite includes carbon nanotubes.

10. The screen of claim 9, wherein the carbon nanotubes are aligned in the polymeric material.

11. (canceled)

12. (canceled)

13. (canceled)

14. The screen of claim 9, wherein the carbon nanotubes are dispersed in the polymeric material without alignment.

15. (canceled)

16. (canceled)

17. (canceled)

18. (canceled)

19. The screen of claim 1, wherein the composite is conductive.

20. The screen of claim 19, wherein the light absorption areas are biased with a voltage potential.

21. (canceled)

22. (canceled)

23. (canceled)

24. (canceled)

25. (canceled)

26. The screen of claim 1, wherein the composite is coated over light absorption areas.

27. A viewing screen comprising:
a viewing screen surface having a plurality of light transmission areas and a plurality of light absorption areas, the light absorption areas including conductive at least one of carbon nanotubes, fullerenes or fullerides embedded in a resinous or polymeric material,
wherein a voltage potential is selected to reduce the accumulation of dust particles on the viewing screen surface.

28. (canceled)

29. (canceled)

30. (canceled)

31. (canceled)

32. A method of preventing particle accumulation on a viewing screen comprising:
providing a viewing screen surface having a plurality of light transmission areas and a plurality of light absorption areas, the light absorption areas including conductive at least one of carbon nanotubes, fullerenes or fullerides embedded in a resinous or polymeric material; and
applying a voltage potential selected to reduce the accumulation of dust particles on the viewing screen surface.

33. The method of claim 32, wherein the voltage potential is a ground voltage potential.

34. The method of claim 32, wherein the voltage potential includes a positive DC component.

35. The method of claim 32, wherein the voltage potential includes a negative DC component.

36. The method of claim 32, wherein the voltage potential includes alternating positive and negative waveforms.
